(19) United States
(12) Patent Application Publication
(10) Pub. No.: US 2015/0159538 A1
(43) Pub. Date: Jun. 11, 2015

(54) COOLING SYSTEM FOR VEHICLE

(71) Applicants: HYUNDAI MOTOR COMPANY, Seoul (KR); KIA MOTORS CORPORATION, Seoul (KR)

(72) Inventor: Won-Young Jeong, Suwon (KR)

(73) Assignees: KIA MOTORS CORPORATION, Seoul (KR); HYUNDAI MOTOR COMPANY, Seoul (KR)

(21) Appl. No.: 14/295,846

(22) Filed: Jun. 4, 2014

(30) Foreign Application Priority Data
Dec. 9, 2013 (KR) 10-2013-0152538

(51) Int. Cl. F01P 3/00; B60H 1/00

(52) U.S. Cl. CPC F01P 3/00; B60H 1/00642

(57) ABSTRACT

A cooling system for a vehicle is provided that includes a water pump interconnected through a cooling water pipe and configured to supply cooling water cooled by a radiator to an engine. An engine thermostat selectively opens and closes the cooling water pipe connected with the radiator based on the temperature of the cooling water discharged from the engine. A heater core is connected with the engine via the cooling water pipe. An automatic transmission fluid (ATF) warmer is mounted within an automatic transmission connected with the engine, is connected with the cooling water pipe and introduced with high-temperature cooling water discharged from the engine, and adjusts the temperature of transmission oil by causing the cooling water and the transmission oil to exchange heat with each other. A valve is also disposed on the cooling water pipe connected with the ATF warmer between the engine and the heater core.

### CROSS-REFERENCE TO RELATED APPLICATION

This application claims priority to and the benefit of Korean Patent Application No. 10-2013-0152538 filed in the Korean Intellectual Property Office on Dec. 9, 2013, the entire contents of which are incorporated herein by reference.

### BACKGROUND

(a) Field of the Invention

The present invention relates to a cooling system for a vehicle, and more particularly, to a cooling system for a vehicle that selectively uses cooling water in a high-temperature state, that cools an engine in a hybrid vehicle using driving force of a motor and driving force of the engine by considering a driving state and whether heating is actuated to prevent unnecessary energy consumption, thereby improving overall fuel efficiency.

(b) Description of the Related Art

In recent years, as a concern regarding energy efficiency and environmental pollution problems has gradually increased, development has increased for an environmentally-friendly vehicle capable of being substantially substituted for a vehicle having an internal combustion engine, and the environmentally-friendly vehicles are typically classified into an electric vehicle which is driven typically using a fuel cell or electricity as a power source, and a hybrid vehicle which is driven using an engine and an electric battery.

Herein, for the electric vehicle that uses a fuel cell, chemical reaction energy of oxygen and hydrogen is converted into electric energy to generate driving force, and during this process, heat energy is generated by chemical reaction in the fuel cell, and as a result, effectively removing generated heat is required to secure performance of the fuel cell. Even in the hybrid vehicle, the driving force is generated by driving the motor using electricity supplied from the fuel cell or the electric battery together with the engine that is actuated with general fuel, and as a result, the performance of the motor may only be secured by effectively removing the heat generated from the fuel cell or the battery, and the motor.

The hybrid vehicle is driven in an electric vehicle (EV) mode driven by the motor for constant-speed driving, gentle driving, and low and middle-speed constant-speed driving, an internal combustion engine and the motor are simultaneously driven for acceleration and sudden acceleration, and the hybrid vehicle is actuated by the internal combustion engine in the state in which the motor is stopped, for high-speed constant-speed driving. Herein, a cooling system of the hybrid vehicle includes a cooling system that has two cooling systems of an electric cooling system and an internal combustion engine cooling system according to a driving source.

As described above, in the cooling system applied to the hybrid vehicle, a heating mode is actuated or cooling water in a high-temperature state, which cools the engine, is supplied to a heater core and an automatic transmission fluid (ATF) warmer according to a driving state of the vehicle to increase indoor heating and transmission oil temperatures. However, in the hybrid vehicle in the related art, the cooling system for the vehicle is maintained in an idle state by actuating the engine to maintain the temperature of the cooling water supplied to the heater core to a predetermined temperature or greater in response to heating when being driven by the motor, but in this state, when the cooling water is supplied to the ATF warmer to exchange heat with transmission oil in addition to the heating, an engine idling loss increases, and thus overall fuel efficiency deteriorates.

The above information disclosed in this section is merely for enhancement of understanding of the background of the invention and therefore it may contain information that does not form the prior art that is already known in this country to a person of ordinary skill in the art.

### SUMMARY

The present invention provides a cooling system for a vehicle that prevents a heat source of cooling water from being lost by preventing cooling water in a high-temperature state, which is generated while cooling an engine in a hybrid vehicle using both driving force of a motor and driving force of the engine, from being supplied to an ATF warmer by considering a driving state and whether heating is actuated, thereby reducing unnecessary energy consumption through minimization of an engine idling loss, and improving fuel efficiency.

An exemplary embodiment of the present invention provides a cooling system for a vehicle that may include: a water pump interconnected via a cooling water pipe and configured to supply cooling water cooled by a radiator to an engine; an engine thermostat configured to selectively open and close the cooling water pipe connected with the radiator based on the temperature of the cooling water discharged from the engine; a heater core connected with the engine via the cooling water pipe; and an ATF warmer mounted within an automatic transmission connected with the engine, connected with the cooling water pipe and introduced with high-temperature cooling water discharged from the engine, and may be configured to adjust the temperature of transmission oil by causing the cooling water and the transmission oil to exchange heat with each other, wherein the cooling system further includes a valve provided on the cooling water pipe connected with the ATF wanner between the engine and the heater core.

The valve may be an electronic type electrically connected with an engine control unit (ECU) connected with the engine and may be opened or closed based on a control signal of the ECU. The ECU may be electrically connected with an air conditioning controller configured to execute cooling or heating of the vehicle and determine whether the heating of the vehicle is actuated based on a signal output from the air conditioning controller. The ECU may be configured to execute actuation of the engine by sensing a driving state of the vehicle when the heating of the vehicle is actuated by the signal output from the air conditioning controller. The air conditioning controller may be electrically connected with an air conditioning fan, disposed within the heater core to blow wind to the interior of the vehicle, to adjust actuation air volume of the air conditioning fan.

According to exemplary embodiments of the present invention, a cooling system for a vehicle may be configured to prevent a heat source of cooling water from being lost by preventing cooling water in a high-temperature state, which is generated while cooling an engine in a hybrid vehicle using both driving force of a motor and driving force of the engine, from being supplied to an ATF wanner by considering a driving state and whether heating is actuated, thereby reducing unnecessary energy consumption through minimization of an engine idling loss and improving fuel efficiency.

An ECU may be configured to adjust a heat exchange amount by adjusting a heat-exchange flow amount of cooling water and transmission oil by adjusting an opening and closing degree of a valve based on an output signal of an air conditioning controller configured to operate interior heating of the vehicle, thereby maximizing driving system friction reduction efficiency by heat-exchange interruption or heat-exchange increment in an ATF warmer.

### BRIEF DESCRIPTION OF THE DRAWINGS

FIG. 1 is an exemplary block configuration diagram of a cooling system for a vehicle according to an exemplary embodiment of the present invention; and

FIGS. 2 and 3 are exemplary operational state diagrams illustrating the flow of cooling water based on a control signal in the cooling system for a vehicle according to the exemplary embodiment of the present invention.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

An exemplary embodiment of the present invention will hereinafter be described in detail with reference to the accompanying drawings. Therefore, configurations illustrated in the exemplary embodiments and the drawings described in the present specification are merely exemplary embodiments of the present invention and do not represent all of the technical spirit of the present invention, and thus it is to be understood that various modified examples, which may replace the configurations, are possible when filing the present application.

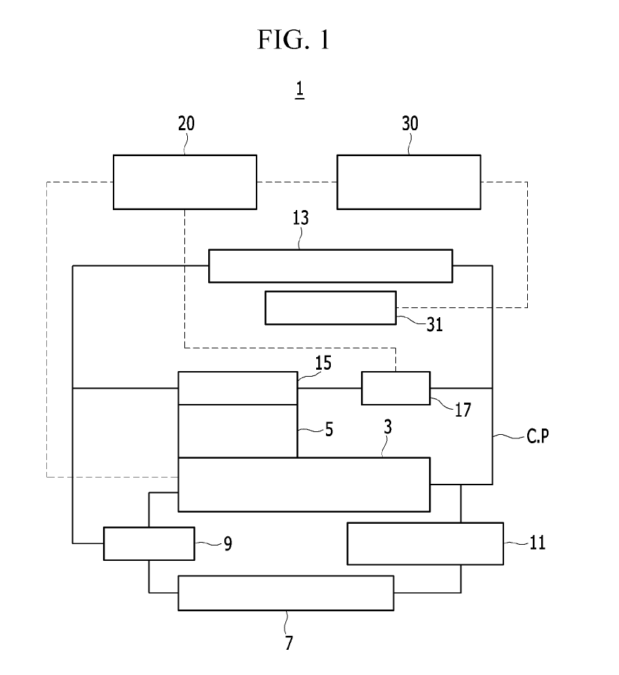

FIG. 1 is an exemplary block configuration diagram of a cooling system for a vehicle according to an exemplary embodiment of the present invention. Referring to FIG. 1, a cooling system 1 for a vehicle according to an exemplary embodiment of the present invention may be configured to prevent a heat source of cooling water from being lost by preventing cooling water in a high-temperature state, which is generated while cooling an engine 3 in a hybrid vehicle using both driving force of a motor and driving force of the engine, from being supplied to an ATF warmer 15 by considering a driving state and whether heating is actuated, thereby reducing unnecessary energy consumption by minimizing an engine idling loss, and improving fuel efficiency. Accordingly, the cooling system 1 may include a water pump 9, an engine thermostat 11, a heater core 13, an ATF warmer 15, and a valve 17.

The water pump 9 may be interconnected via a cooling water pipe C.P where cooling water flows and may be configured to supply the engine 3 with cooling water cooled through heat exchange with outdoor air in a radiator 7. The cooling water supplied to the engine 3 may be heated through heat exchange while cooling the overheated engine 3 to be discharged from the engine 3 in a substantially high-temperature state. The engine thermostat 11 may be configured to selectively open and close the cooling water pipe C.P, connected with the radiator 7, based on the temperature of the cooling water discharged from the engine 3 to selectively introduce cooling water, which is to be cooled, into the radiator 7.

The heater core 13 may be connected with the engine 3 via the cooling water pipe C.P and may be configured to receive a heat source from the cooling water in the high-temperature state to use the received heat source for heating the vehicle. In addition, the ATF warmer 15 may be mounted within an automatic transmission 5 connected with the engine 3, may be connected with the cooling water pipe C.P to be introduced with the high-temperature cooling water discharged from the engine 3, and may be configured to cause the cooling water and the transmission oil to exchange heat with each other to control the temperature of the transmission oil. The valve 17 may be disposed on the cooling water pipe C.P connected with the ATF warmer 15 between the engine 3 and the heater core 13.

Further, the valve 17 may be configured by an electronic type that may be electrically connected with an ECU 20 connected with the engine 3, and may be opened or closed according to a control signal of the ECU 20. In particular, the ECU 20 may be electrically connected with an air conditioning controller 30 configured to operate cooling or heating of the vehicle, and determine whether the heating of the vehicle is actuated based on a signal output from the air conditioning controller 30. The ECU 20 may also be configured to operate actuation of the engine 3 by sensing a driving state of the vehicle when the heating of the vehicle is actuated by the signal output from the air conditioning controller 30.

Meanwhile, the air conditioning controller 30 may be electrically connected with an air conditioning fan 31, disposed within the heater core 13 to blow wind to the interior of the vehicle, to adjust air volume of the air conditioning fan 31. Hereinafter, the actuation and an action of the cooling system 1 for a vehicle according to the exemplary embodiment of the present invention, which is configured as described above, will be described in detail.

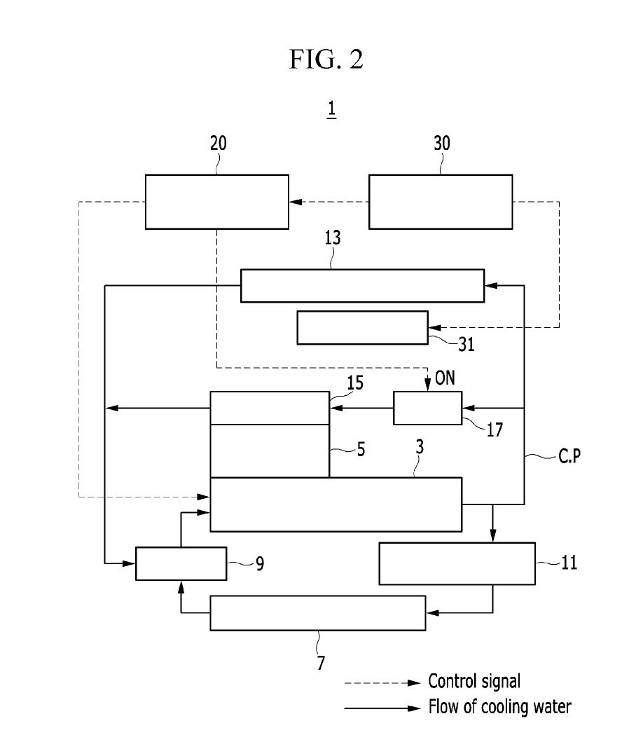

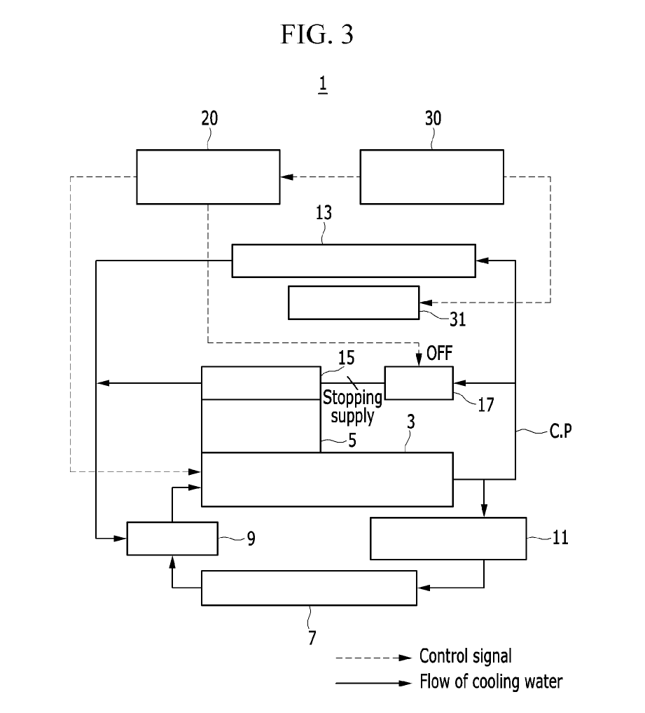

FIGS. 2 and 3 are exemplary operational state diagrams illustrating the flow of cooling water based on a control signal in the cooling system for a vehicle according to the exemplary embodiment of the present invention. First, as illustrated in FIG. 2, in a hybrid vehicle, the ECU 20 may be configured to output a control signal to the valve 17 to open the valve 17 when both the engine 3 and the motor are driven, or the vehicle is driven in an internal combustion engine mode using the engine 3 as a driving source or in response to determining by the ECU 20 that interior heating of the vehicle is not actuated by the signal output from the air conditioning controller 30.

Further, cooling water in a substantially high-temperature state (e.g., temperature above a predetermined threshold) discharged from the engine 3, may be introduced into each of the heater core 13 and the ATF warmer 15 along the cooling water pipe C.P, and the cooling water in a substantially high-temperature state (e.g., temperature above a predetermined threshold) introduced into the ATF warmer 15, may increase the temperature of the transmission oil through the heat exchange with the transmission oil to reduce a friction component, thus reducing driving resistance of the automatic transmission 5. In particular, the engine thermostat 11 may be configured to introduce the cooling water into the radiator 7 by opening the cooling water pipe C.P connected with the radiator 7 in response to determining that the temperature of the cooling water discharged from the engine 3 is equal to or greater than a predetermined temperature. The radiator 7 may be configured to cool the introduced cooling water in a high-temperature state through the heat exchange with the outdoor air, and the water pump 9 may be configured to supply the cooling water cooled in the radiator 7 and the cooling water passing through the heater core 13 and the ATF warmer 15 to the engine 3 again to circulate the cooling water.

Meanwhile, as illustrated in FIG. 3, when the hybrid vehicle is driven in an EV mode using the motor as the driving source and when the heating is required, the ECU 20 may be configured to determine whether the heating of the vehicle is actuated through the signal output from the air conditioning controller 30, and increase the temperature of the cooling water to a predetermined temperature or greater by actuating and maintaining the engine 3 in the idle state to secure an interior heating calorie.

In particular, the ECU 20 may be configured to prevent the cooling water in a high-temperature state, which is discharged from the engine 3, from being introduced into the ATF warmer 15 by operating the valve 17 in a closed state. Then, the cooling water in a high-temperature state may not be supplied to the ATF warmer 15 to prevent the cooling water from exchanging heat with transmission oil that is not used in the vehicle that is driven in the EV mode. Therefore, loss of a cooling water heat source by unnecessary heat exchange may be minimized, and as a result, the cooling water may pass through the heater core 13. In particular, the air conditioning controller 30 may be configured to adjust the air volume of the air conditioning fan 31 according to a user setting of an interior temperature or adjust of air volume strength, and secure an interior heating calorie with the heat source of the cooling water in a high-temperature state supplied to the heater core 13.

Meanwhile, when the engine 3 and the motor are driven together or only the driving force of the engine 3 is used for driving the vehicle, the ECU 20 may be configured to adjust the flow rate of the cooling water introduced into the ATF warmer 15 by adjusting the opening and closing degree of the valve 17 to adjust a heat exchange amount with the transmission oil, thus optimally adjusting the temperature of the transmission oil according to the driving state.

Accordingly, when the cooling system 1, which is configured as above, is applied, a heat source of cooling water may be prevented from being lost by preventing cooling water in a high-temperature state, which is generated while cooling the engine 3 in a hybrid vehicle using both driving force of the motor and driving force of the engine 3, from being supplied to the ATF warmer 15 by considering a driving state and whether heating is actuated, thus reducing unnecessary energy consumption through minimization of an idling loss of the engine 3 which is maintained in an idle state, in the EV mode in which the vehicle is driven by the motor, and thus improving fuel efficiency. The ECU 20 may be configured to adjust a heat exchange amount by adjusting a heat-exchange flow amount of the cooling water and the transmission oil by adjusting the opening and closing degree of the valve 17 based on an output signal of the air conditioning controller 30, which may be configured to adjust interior heating of the vehicle, to maximize driving system friction reduction efficiency by heat-exchange interruption or heat-exchange increment in the ATF warmer 15.

While this invention has been described in connection with what is presently considered to be exemplary embodiments, it is to be understood that the invention is not limited to the disclosed exemplary embodiments, but, on the contrary, is intended to cover various modifications and equivalent arrangements included within the spirit and scope of the accompanying claims.

### DESCRIPTION OF SYMBOLS

1 : Cooling system

3 : Engine

5 : Automatic transmission

7 : Radiator

9 : Water pump

11 : Engine thermostat

13 : Heater core

15 : ATF warmer

17 : Valve

20 : ECU

30 : Air conditioning controller

31 : Air conditioning fan

What is claimed is:

1. A cooling system for a vehicle, comprising:
a water pump interconnected through a cooling water pipe and configured to supply cooling water cooled by a radiator to an engine;
an engine thermostat configured to selectively open and close the cooling water pipe connected with the radiator based on the temperature of the cooling water discharged from the engine;
a heater core connected with the engine via the cooling water pipe; and
an automatic transmission fluid (ATF) wanner mounted within an automatic transmission connected with the engine, and connected with the cooling water pipe and introduced with high-temperature cooling water discharged from the engine, and configured to adjust the temperature of transmission oil by causing the cooling water and the transmission oil to exchange heat with each other,
wherein the cooling system further includes a valve disposed on the cooling water pipe connected with the ATF warmer between the engine and the heater core.

2. The system of claim 1, wherein the valve is configured by an electronic type electrically connected with an engine control unit (ECU) connected with the engine, and is opened or closed based on a control signal of the ECU.

3. The system of claim 2, wherein the ECU is electrically connected with an air conditioning controller configured to adjust cooling or heating of the vehicle, and determine whether the heating of the vehicle is actuated based on a signal output from the air conditioning controller.

4. The system of claim 3, wherein the ECU is configured to execute actuation of the engine by sensing a driving state of the vehicle when the heating of the vehicle is actuated by the signal output from the air conditioning controller.

5. The system of claim 3, wherein the air conditioning controller is electrically connected with an air conditioning fan, disposed within the heater core to blow wind to the interior of the vehicle, and is configured to adjust actuation air volume of the air conditioning fan.
